(19) United States
(12) Patent Application Publication
(10) Pub. No.: US 2007/0277501 A1
(43) Pub. Date: Dec. 6, 2007

(54) Fluid dynamic power generator and methods

(76) Inventor: Sidney Dale Sorenson, Frisco, TX (US)

Correspondence Address: MICHAEL T. KONCZAL, PATENT ATTORNEY, P.O. BOX 863656, PLANO, TX, 75086, US

(21) Appl. No.: 11/549,471

(22) Filed: Oct. 13, 2006

Related U.S. Application Data
(60) Provisional application No. 60/727,101, filed on Oct. 14, 2005.

(51) Int. Cl. F02K 3/00; B64G 1/40

(52) U.S. Cl. 60/204; 60/269

(57) ABSTRACT

Fluid dynamic power generation methods and associated apparatus are disclosed for introducing a fluid through an intake into a convergent-divergent stream duct adapted for accelerating the fluid. The fluid is cooled within the convergent-divergent stream duct and ejected through a variable area exhaust port, the ejected fluid having a higher kinetic energy than the intake fluid, for conversion to useable power.

### PRIORITY ENTITLEMENT

This application claims priority based on Provisional Patent Application Ser. No. 60/727,101 filed on Oct. 14, 2005, incorporated herein for all purposes. This application and the aforementioned Provisional patent application have a common inventor.

### TECHNICAL FIELD

The invention relates to power generators and methods for using fluid media for power generation. More particularly, the invention relates to fluid dynamic power generation systems and methods operable at relatively low temperatures. A water cooled fluid dynamic generator of the invention is capable of yielding useful quantities of mechanical energy from relatively low intensity energy sources such as, for example, ambient air driven by wind.

### BACKGROUND OF THE INVENTION

The following equations may be helpful in understanding the application of some of the principles of the basic physics of fluid dynamics as they relate to the art and practice of the present invention. The engine described in this patent works by changing the density (ρ) of the working fluid and through that the fluid's stagnation pressure (Pₛ).
Pₛ=P+ρυ² (1)
Where υ is velocity, and P is pressure. Under eisentropic conditions Pₛ is constant. Changing ρ when υ=0 also has no effect on Pₛ. Ram jets take advantage of this by taking a high speed fluid and slowing it until υ approaches zero and P approaches Pₛ. So if υᵢ is the intake velocity, υₑ is the exhaust velocity, ρᵢ is the intake density, and ρₑ is the exhaust density.

$${v}_{e} = {v}_{i} \sqrt{\frac{{ρ}_{i}}{{ρ}_{e}}} \qquad ( 2 )$$

As a result if ρₑ=ρᵢ/2, υₑ=υᵢ\sqrt{2}=1.41υᵢ. This represents a 41% increase in momentum and a doubling in energy. The engine described in this patent cools the fluid at high velocity increasing Pₛ. If Pₛᵢ is the intake stagnation pressure and Pₛₑ is the exhaust stagnation pressure.
Pₛₑ=Pₛᵢ+(ρₑ−ρᵢ)υ² (3)
If υᵢ=0 with both intake and exhaust pressures both equal to Pₛᵢ

$${v}_{e} = v \sqrt{\frac{{ρ}_{e} - {ρ}_{i}}{{ρ}_{e}}} \qquad ( 4 )$$

So ρₑ=2ρᵢ υₑ=υ/\sqrt{2}=0.707υ implying the power gain of this engine is limited only by υ. In reality viscosity limits υ in high temperature versions of this engine and dewpoint limits υ in low temperature versions of this engine such as the one described in this patent.

Application of the principles of fluid dynamics to the field of power generation described in terms of Equations 3 and 4 has been limited, and has met with several problems. Prior art efforts at using the principles of fluid dynamics to extract useable energy from changes in stagnation pressure have required relatively high temperatures for their operation.

It has long been known that if the speed of a fluid particle increases as it travels along a streamline, the pressure of the fluid must decrease, and conversely. This relationship of pressure and motion is known as Bernoulli's Principle. It is known in the arts to attempt to apply the principles of fluid dynamics to utilize changes in the pressure of a fluid to generate mechanical force for direct use or for conversion into other forms of useable energy such as electrical power. Previous attempts at developing water cooled fluid dynamic generators are described in U.S. Pat. Nos. 3,564,850 and 5,083,429. Both the generator described in the '850 patent and the generator described in the '429 patent operate by attempting to harness energy generated by causing changes in stagnation pressure through changing the temperature of a moving fluid. For various reasons, neither of these two generators can be applied in practical low-temperature power generation applications. The compression tube of the '429 patent, for example, requires an operating temperature exceeding 200° C. Although there are applications in which hot gas is readily available, such as the exhaust from gas turbines, such a generator is inoperable in less heat-intensive environments, such as typical ambient temperature. Similarly, the approach taken by the '850 patent requires accelerating the fluid to a speed of exactly Mach one. Unfortunately, maintaining this speed over an appreciable distance requires the application of a significant amount of heat to the body of fluid, in this case gas, which is not always practical.

Another problem with the approaches used in the prior art is that each used supersonic flow at the throat to limit flow rates. This practice is problematic for a low temperature generator. As a gas accelerates, its temperature decreases. Under most conditions it will reach dew point long before it reaches or exceeds Mach 1, resulting in a wet gas. Accelerating a wet gas results in significant energy losses, therefore the gas temperature must be below dew point at the injection point and thus significantly less than Mach 1 under most conditions. This is compounded by the fact that even though equations 3 and 4 do capture the qualitative operation of engines with subsonic flows, they can be a full order of magnitude off when predicting the actual performance of a practical engine.

There is a perpetual need for practical means for generating useable forms of energy using available renewable resources. Due to these and other problems existing in the arts, it would be useful and advantageous to provide a fluid-dynamic power generator operable with wet gasses at relatively low temperatures.

### SUMMARY OF THE INVENTION

In carrying out the principles of the present invention in accordance with preferred embodiments thereof, a power generation method includes a step of introducing a fluid through an intake into a convergent-divergent stream duct adapted for accelerating the fluid. In further steps, the fluid is cooled within the convergent-divergent stream duct and ejecting through a variable area exhaust port. As a result of the operation of the invention, the ejected fluid has higher kinetic energy than the intake fluid.

According to one aspect of the invention, methods for using fluid media for generating useable power include embodiments using a step of introducing air having a temperature/dew point differential of at least ten degrees Fahrenheit through an intake of a fluid generator apparatus.

According to another aspect of the invention, methods for using fluid media for generating useable power include a step of injecting a cooling mist into the fluid.

According to yet another aspect of the invention, methods for using fluid media for generating useable power include the step of dynamically controlling the flow rate of the fluid by adjusting an exhaust port.

According to still another aspect of the invention, a method embodiment includes steps for dynamically controlling the cooling of the fluid within the convergent-divergent stream duct by adjusting the rate of injecting a cooling mist into the convergent-divergent stream duct.

According to another aspect of the invention, a fluid-dynamic power generator apparatus includes an intake for receiving a fluid and a convergent-divergent stream duct configured for accelerating the fluid. A cooling mist inlet is provided for introducing a cooling mist into the fluid. A variable area exhaust port is coupled to the convergent-divergent stream duct for ejecting the fluid from the fluid-dynamic power generator, wherein the ejected fluid has a higher kinetic energy than the intake fluid.

The invention has advantages including but not limited to providing a clean source of useable power generated from relatively low intensity input. These and other features, advantages, and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified sectional side view depicting the operational aspects of the apparatus and methods of the invention;

FIG. 2 is a top side perspective view of an example of a preferred embodiment of power generation apparatus of the invention;

FIG. 3 is a process flow diagram illustrating steps in a preferred method of the invention; and

FIG. 4 is a process flow diagram illustrating steps in another example of a preferred method of the invention.

References in the detailed description correspond to like references in the various drawings unless otherwise noted. Descriptive and directional terms used in the written description such as top, bottom, upper, side, etc., refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DESCRIPTION OF PREFERRED EMBODIMENTS

In general, the invention provides a fluid-dynamic power generator apparatus and associated methods which overcome the foregoing and other practical problems which have long since characterized the prior art. In accordance with the broader aspects of the invention, a fluid-dynamic power generator preferably operates utilizing either dry or wet exhaust, thereby enabling the use of fluid media that includes liquids that do not completely evaporate. By utilizing liquids that do not completely evaporate, the invention can operate using widely available and inexpensive coolants such as, for example, water and brine, and can be operated with input fluid temperatures as low as 70° F. provided that the dew point is at least 10° F. less than the fluid input temperature. The greater the differential between the temperature and dew point, the more efficient the generator.

The apparatus and methods of the present invention are capable of achieving useable power levels with efficiency equal to or greater than that known for other types of power generators designed for the production of power using renewable resources. The invention has many advantages including the capability to generate electricity using relatively cheap inputs such as for example, ambient air moved by wind, and unpurified water. For convenience in describing preferred embodiments of the invention, the present description adopts the convention of referring to ambient air as an example of a fluid and water as an example of a coolant. These examples are intended to be demonstrative of an advantageous embodiment of the invention and not restrictive. Those skilled in the arts will appreciate that in some operating environments alternative fluids, either liquid or gaseous, and alternative coolants, may be used without departure from the principles of the invention.

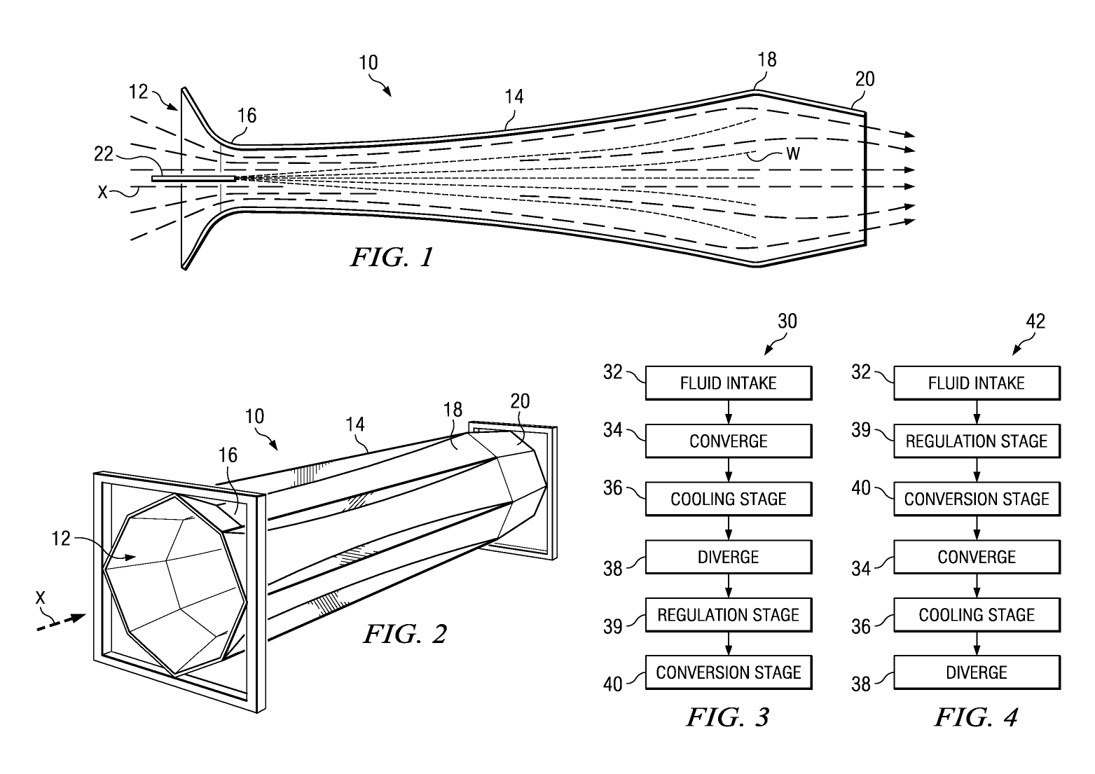

Now referring primarily to FIG. 1, the apparatus, operating principles, and methods of the invention are illustrated in a simplified sectional side view. A fluid-dynamic power generator 10, has an intake 12 through which fluid, such as air, may enter. The intake fluid is denominated by arrows X. The intake 12 leads directly to a convergent-divergent stream duct 14, delineated by a throat 16, which constrains the fluid X from the input 12, and an exhaust end 18, coupled to an exhaust port 20. The exhaust port 20 is preferably a nozzle structure having a variable aperture such that the cross-sectional area through which the fluid X is ejected may be varied as further described. The variable area exhaust port 20 is used to control the fluid X velocity at the throat 16. Due to the shape of the convergent-divergent stream duct 14, the fluid X accelerates as it travels from the intake 12 to the throat 16. A mist, in this case water W, is introduced at the throat 16 through a cooling mist inlet 22, cooling the fluid X and increasing its stagnation pressure. The fluid X is continuously intercooled as it decelerates from the throat 16 to the exhaust end 18, further increasing its stagnation pressure. At the exhaust end 18, the pressure is greater than at the intake 12. From the exhaust end 18, the fluid X is accelerated through the exhaust nozzle 20 where it may be used as thrust, for example to move a vehicle or drive a turbine. As the fluid X accelerates from the intake 12 to the throat 16, the accelerating fluid X tends to cool. If the fluid X were to cool to its dew point, the thrust output would fall off dramatically. In order to avoid or reduce a loss in thrust output, the variable area exhaust port 20 is preferably used to control back pressure, and in turn control fluid X velocity at the throat 16.

With the framework of the above-described apparatus, steps, and applicable physical principles in view, understanding of the invention by those skilled in the arts may be enhanced by consideration of the following assumptions and algorithms. First, the present invention operates on the assumption that stagnation pressure can be changed without significantly altering the momentum of a moving fluid. This assumption is supported by physical principles known in the arts relating to the properties and behavior of fluids and by experimental testing of the present invention. Second, the present invention operates on the assumption that computational fluid dynamics currently only approximate the real world, so multiple algorithms need to be explored in an attempt to find the best match. Thermal Relaxation, as described in chapter 4 of J. P. M. Trusler's, Physical Acoustics and Metrology of Fluids, Adam Hilger Ltd., England 1991, incorporated herein by this reference, indicates that the second assumption is correct because it implies that an accelerating fluid constantly experiences minute changes in stagnation pressure.

Understanding of the invention may be enhanced by reference to the following description of its operating principles. The first algorithm used in the development of the present invention begins with the adaptation of two different energy equations known in classical fluid dynamics. The first energy equation is applicable to dry air:

$${E}_{k} = {h}_{steam} ( T ) {n}_{steam} + {h}_{air} ( T ) {n}_{air} + \frac{m {v}^{2}}{2} \qquad ( 5 )$$

where; Eₖ=dry air energy constant, hₛₜₑₐₘ(T)=the specific heat of steam as a function of temperature, nₛₜₑₐₘ=the number of moles of steam, hₐᵢᵣ(T)=the specific heat of air as a function of temperature, nₐᵢᵣ=the number of moles of air, T=temperature, m=mass, and v=velocity. Since Equation 5 ignores evaporative cooling, a second energy equation for wet air may also be used:

$${E}_{kw} = {n}_{air} {h}_{air} ( T ) + {n}_{water} {h}_{water} ( T ) + {n}_{steam} {h}_{steam} ( T ) + \frac{m {v}^{2}}{2} \qquad ( 6 )$$

in which; E_{kw}=wet air energy constant, n_{water}=the number of moles of water, and h_{water}(T) the specific heat of water as a function of temperature.

In implementing the invention as described by the first algorithm, the relationship of Equation 5 may be used in conjunction with mass and momentum conservation equations to describe the values of temperature (T), pressure (P), density (ρ), and velocity (υ) for the flow, ignoring the heat in the liquid water. Assuming that pressure (P) and velocity (υ) are constant, the relationship of Equation 6 may be used to describe changes in temperature (T), density (ρ), and stagnation pressure (Pₛ). In a wet fluid, balancing Equation 6 can be very difficult. Minor changes in T result in significant nonlinear changes in the number of moles of steam (nₛₜₑₐₘ). Due to the high heat vaporization, changes in nₛₜₑₐₘ impact the total heat in the system far more than the simple heating of the other fluid components. The dEₜ/dT equation (Equation: 12) is used to address this problem, as further discussed below. Subsequently, frontal area (A) is incremented and the application of Equations 5 and 6 is reiterated. This algorithm may be repeated and the results applied to control the flow through the apparatus, resulting in changes to temperature (T), density (ρ), and stagnant pressure (Pₛ). Thus, high velocity fluid, in this case air mixed with water, are ejected from the apparatus and may be converted into useable power through mechanical means.

A second, and presently more preferred, algorithm descriptive of the practice of the invention also makes use of the relationships shown by Equations 5 and 6, but constrains pressure (P) rather than frontal area (A). First, the inlet velocity (υ), pressure (P), temperature (T). Next, the number of moles of air (nₐᵢᵣ) and water vapor (nₛₜₑₐₘ) present in a unit of inlet fluid may be calculated based upon the inlet parameters and dew point. Subsequently, the energy constant (Eₖ) is calculated using Equation 6. Density (ρ) may be computed beginning with the relationship:
PV=(nₛₜₑₐₘ+nₐᵢᵣ)RT (7)
where R is the gas constant. Fluid density (ρ) is calculated ignoring the volume of liquid water that may be present. The mass of liquid water is accounted for when calculating density (ρ) per the following formulas:

$$\begin{matrix}V = \frac{( {n}_{steam} + {n}_{air} ) R T}{P} & ( 8 ) \\ ρ = \frac{{m}_{steam} + {m}_{water} + {m}_{air}}{V} & ( 9 )\end{matrix}$$

where: nₛₜₑₐₘ=the number of moles of water vapor in the particle; nₐᵢᵣ=the number of moles of air in the particle; mₛₜₑₐₘ=the mass of the water vapor in the particle; m_{water}=the mass of the liquid water suspended in the particle; and mₐᵢᵣ=the mass of the air vapor in the particle; and V=volume.

Once the actual density (ρ) has been calculated, stagnation pressure (Pₛ) is calculated using velocity (υ), pressure (P) and density (ρ), as described in Equation 1. The pressure (P) is then stepped by a selected amount, preferably one Pascal, and a new velocity (v) is computed using the relationship:

$$v = \sqrt{\frac{{P}_{s} - P}{ρ}} \qquad ( 10 )$$

The energy equations (Equations 5 and 6) are then balanced resulting in a new value for temperature (T). The above steps in the second algorithm are preferably then repeated, each iteration updating the performance of the apparatus.

Balancing the energy equations is not trivial. In order to determine the number of moles of steam (nₛₜₑₐₘ), taking,

$$V = \frac{( {n}_{steam} + {n}_{air} ) R T}{P} \qquad ( 8 )$$

and realizing that the total pressure P is the sum of the air pressure and steam pressure, P=Pₐᵢᵣ+Pₛₜₑₐₘ, Equation 8 may be expressed as
V=(nₛₜₑₐₘ+nₐᵢᵣ)RT/(Pₐᵢᵣ+Pₛₜₑₐₘ), so that,

$${n}_{steam} = \frac{{n}_{air} {P}_{steam}}{P - {P}_{steam}} \qquad ( 11 )$$

Through much study and experimentation, the following equation has been derived:

$$\begin{matrix}ⅆ {E}_{t} / ⅆ T = {n}_{air} \times ⅆ {h}_{air} ( T ) + \\ \frac{{n}_{air} \times ⅆ {P}_{steam} ( T ) \times ( {h}_{steam} ( T ) - {h}_{water} ( T ) )}{P - {P}_{steam} ( T )} \times \\ ( 1 + \frac{{P}_{steam} ( T )}{P - {P}_{steam} ( T )} )\end{matrix} \qquad ( 12 )$$

where: T=temperature; Eₜ=thermal energy; P=total pressure; Pₛₜₑₐₘ=pressure of water vapor or steam; nₐᵢᵣ=number of moles of air; hₐᵢᵣ(T)=the specific heat of air as a function of temperature; dhₐᵢᵣ(T)=is the first order derivative of the specific heat of air as a function of temperature; (this can be approximated using C_{Pair}×T); hₛₜₑₐₘ=(T) the specific heat of steam as a function of temperature; h_{water}(T)=the specific heat of water as a function of temperature; Pₛₜₑₐₘ(T)=pressure of steam as a function of temperature; dPₛₜₑₐₘ(T)=the first order derivative of the pressure of steam as a function of temperature. The relationship of Equation 12 describes the operation of the apparatus of the invention, and may be used to determine and refine the physical parameters of apparatus of the invention such as convergent-divergent stream duct configurations, variable exhaust port configuration and operation, and cooling mist input configuration and operation. The description and predictions of Equation 12 may also be used to dynamically adjust the operation of the apparatus in real time in order to optimize power output according to operating conditions.

The second algorithm, described above, is descriptive of the presently preferred embodiment of the invention. An alternative view of the operation of the invention is also shown in FIG. 3. A simplified process flow diagram illustrates the methods 30 of the invention. Fluid intake 32 is shown at the top of FIG. 3. It should be understood, however, that fluid intake may be regulated during operation of the invention by controlling the exhaust. In a convergent stage 34, the area occupied by the fluid is decreased, causing the velocity of the fluid to increase. The fluid then enters a cooling stage 36 during which its stagnation pressure rises. Following a divergent stage 38 the fluid output is preferably controlled in a regulation stage 39 using a variable exhaust, thereby in turn regulating the intake according to operating conditions. In a conversion stage 40, the energy of the moving fluid is captured by mechanical means such as a fan or turbine. There are numerous implementations possible for the conversion stage, which may be used without departure from the invention as long as the change in the pressure of the fluid is harnessed to produce useable energy.

FIG. 4 is a process flow diagram illustrating steps in another example of a preferred method of the invention. In this example, the regulation stage 39 is shown immediately following the fluid intake 32. It is believed that this configuration is particularly advantageous for use with some coolants (W in FIG. 1) such as brines in order to control caking of salts and other solids. Again referring to FIG. 4, the conversion stage 40 may also be performed at the fluid intake 32 rather than, or in addition to, further downstream as shown in FIG. 3.

The methods and apparatus of the invention provide advantages including but not limited to one or more of the following: providing means for producing useable power from low intensity energy sources; providing a fluid-dynamic generator operable at relatively low temperatures; providing a power source that is cost-effective to operate in many environments. While the invention has been described with reference to certain illustrative embodiments, those described herein are not intended to be construed in a limiting sense. For example, variations or combinations of steps in the embodiments shown and described may be used in diverse particular cases, such as a desalination plant in an arid coastal location, or an electric power generating plant, without departure from the invention. Such implementations may alternatively emphasize particular advantages of the invention. Modifications and combinations of the illustrative embodiments as well as other advantages and embodiments of the invention will be apparent to persons skilled in the arts upon reference to the drawings, description, and claims.

I claim:

1. A power generation method comprising the steps of:
introducing a fluid through an intake into a convergent-divergent stream duct adapted for accelerating the fluid;
cooling the fluid within the convergent-divergent stream duct; and
ejecting the fluid from the convergent-divergent stream duct by means of a variable area exhaust port, whereby the ejected fluid has higher kinetic energy than the intake fluid.

2. A method according to claim 1 wherein the fluid further comprises a gas having a temperature/dew point differential of at least ten degrees Fahrenheit.

3. A method according to claim 1 wherein the fluid further comprises ambient air introduced through the intake by the force of wind and having a temperature/dew point differential of at least ten degrees Fahrenheit.

4. A method according to claim 1 further comprising the step of injecting a cooling mist into the convergent-divergent stream duct for cooling the fluid.

5. A method according to claim 1 further comprising the step of injecting a cooling mist comprising water into the convergent-divergent stream duct for cooling the fluid.

6. A method according to claim 1 further comprising the step of dynamically controlling the flow rate of the fluid introduced at the intake by adjusting the variable area exhaust port.

7. A method according to claim 1 further comprising the step of dynamically controlling the cooling of the fluid within the convergent-divergent stream duct by adjusting the rate of injecting a cooling mist into the convergent-divergent stream duct.

8. A method according to claim 1 further comprising the step of dynamically controlling the rate of the ejected fluid described using the relationship,
$$\begin{matrix}ⅆ {E}_{t} / ⅆ T = {n}_{air} \times ⅆ {h}_{air} ( T ) + \\ \frac{{n}_{air} \times ⅆ {P}_{steam} ( T ) \times ( {h}_{steam} ( T ) - {h}_{water} ( T ) )}{P - {P}_{steam} ( T )} \times \\ ( 1 + \frac{{P}_{steam} ( T )}{P - {P}_{steam} ( T )} )\end{matrix} \qquad ( 12 )$$

9. A fluid-dynamic power generator comprising:
an intake for receiving a fluid into the fluid-dynamic power generator;
a convergent-divergent stream duct in communication with the intake, the convergent-divergent stream duct configured for accelerating the fluid;
a cooling mist inlet for introducing a cooling mist into the fluid; and
a variable area exhaust port in communication with the convergent-divergent stream duct for ejecting the fluid from the fluid-dynamic power generator;
whereby the ejected fluid has a higher kinetic energy than the intake fluid.

10. A fluid-dynamic power generator according to claim 9 adapted for utilizing a fluid comprising ambient air.

11. A fluid-dynamic power generator according to claim 9 adapted for utilizing a cooling mist comprising water.

12. A fluid-dynamic power generator according to claim 9 wherein the convergent-divergent stream duct configuration is described using the relationship,
$$\begin{matrix}ⅆ {E}_{t} / ⅆ T = {n}_{air} \times ⅆ {h}_{air} ( T ) + \\ \frac{{n}_{air} \times ⅆ {P}_{steam} ( T ) \times ( {h}_{steam} ( T ) - {h}_{water} ( T ) )}{P - {P}_{steam} ( T )} \times \\ ( 1 + \frac{{P}_{steam} ( T )}{P - {P}_{steam} ( T )} )\end{matrix} \qquad ( 12 )$$

13. A fluid-dynamic power generator according to claim 9 wherein the cooling mist injection is described using the relationship,
$$\begin{matrix}ⅆ {E}_{t} / ⅆ T = {n}_{air} \times ⅆ {h}_{air} ( T ) + \\ \frac{{n}_{air} \times ⅆ {P}_{steam} ( T ) \times ( {h}_{steam} ( T ) - {h}_{water} ( T ) )}{P - {P}_{steam} ( T )} \times \\ ( 1 + \frac{{P}_{steam} ( T )}{P - {P}_{steam} ( T )} )\end{matrix} \qquad ( 12 )$$
